(19) United States
(12) Patent Application Publication
(10) Pub. No.: US 2010/0146882 A1
(43) Pub. Date: Jun. 17, 2010

(54) INSULATED GLASS UNIT (IGU) AND A POINT FIXING APPARATUS FOR AN IGU

(75) Inventors: Murray Robert Clair, Wallsend (AU); Craig Adam McWillam, East Gosford (AU)

Correspondence Address: SEED INTELLECTUAL PROPERTY LAW GROUP PLLC, 701 FIFTH AVE, SUITE 5400, SEATTLE, WA, 98104, US

(73) Assignee: NUPRESS TOOLS PTY LIMITED, Cardiff (AU)

(21) Appl. No.: 12/594,329

(22) PCT Filed: Apr. 2, 2008
(86) PCT No.: PCT/AU2008/000464

§ 371 Date: Jan. 5, 2010

Related U.S. Application Data
(60) Provisional application No. 60/907,426, filed on Apr. 2, 2007.

(51) Int. Cl. E06B 3/667; E06B 7/16; E04C 2/54

(52) U.S. Cl. 52/204.62; 52/788.1; 52/786.13

(57) ABSTRACT

A point fixing apparatus is described. The point fixing apparatus is suitable for mounting an insulated glass unit (IGU) to a support structure, the IGU having first and second panes of glass spaced apart from one another, the point fixing apparatus including: a spacer apparatus for spacing the first and second panes from one another; a first clamping block configured for clamping the first glass pane against the spacer apparatus; a second clamping block configured for clamping the second glass pane against the spacer apparatus; and one or more stop devices configured to inhibit overtightening of the clamping blocks against the panes and spacer apparatus, the one or more stop devices disposed between the clamping blocks when assembled. Also described is an insulated glass unit (IGU) which includes: first and second panes of glass; point fixing apparatus for fixing the IGU to a support structure, the point fixing apparatus including a spacer for spacing the first and second panes from one another; a first clamping block for clamping the first glass pane against the spacer when assembled; a second clamping block for clamping the second glass pane against the spacer when assembled; and one or more stop devices configured to inhibit overtightening of the clamping blocks against the panes and spacer apparatus, the one or more stop devices disposed between the clamping blocks when assembled. A method of assembling an IGU is also described.

### FIELD OF THE INVENTION

The present invention relates generally to insulated glass units (IGUs), devices for mounting IGUs and a method of mounting IGUs.

### BACKGROUND TO THE INVENTION

Insulated Glass Units (IGUs), also known as double glazing units, are generally formed from two spaced apart panes of glass separated by a peripheral spacing frame. The frame and glass forms a hermetically sealed chamber so as to provide a transparent insulating barrier. However, the peripheral frames are bulky, expensive and unsightly, and interfere with the view through the glass panes, especially when an IGU glass wall is formed by abutting several IGUs together in an edge to edge manner.

Other arrangements use point fixing structures which have spacing donuts between the glass panes to mount the IGUs. Point fixing devices allow the use of much slimmer peripheral frames. However, these point fixing means are difficult to assemble, partly because it is difficult to provide tight thickness and/or flatness tolerances on the glass panels. Therefore, when the glass panes are clamped against the spacing donuts, sealant and sealing washers are squeezed by differing degrees, which compromises the seal even before it is installed.

The present invention seeks to ameliorate one or more of the abovementioned disadvantages.

### SUMMARY OF THE INVENTION

According to one aspect of the present invention there is provided a point fixing apparatus for mounting an insulated glass unit (IGU) to a support structure, the IGU having first and second panes of glass spaced apart from one another, the point fixing apparatus including: a spacer apparatus for spacing the first and second panes from one another; a first clamping block configured for clamping the first glass pane against the spacer apparatus; a second clamping block configured for clamping the second glass pane against the spacer apparatus; and one or more stop devices configured to inhibit overtightening of the clamping blocks against the panes and spacer apparatus, the one or more stop devices disposed between the clamping blocks when assembled.

According to another aspect of the present invention there is provided an insulated glass unit (IGU) which includes: first and second panes of glass; point fixing apparatus for fixing the IGU to a support structure, the point fixing apparatus including a spacer for spacing the first and second panes from one another; a first clamping block for clamping the first glass pane against the spacer when assembled; a second clamping block for clamping the second glass pane against the spacer when assembled; and one or more stop devices configured to inhibit overtightening of the clamping blocks against the panes and spacer apparatus, the one or more stop devices disposed between the clamping blocks when assembled.

Preferably an axle is provided for supporting the clamping blocks when assembled. In one preferred embodiment the spacer assembly is mounted on the axle. Preferably the one or more stop devices are mounted on or integral with the axle. Although in one preferred arrangement, the one or more stop devices be mounted on or integral with the axle, the one or more stop devices may also extend from or be connected to the spacer apparatus and abut against one or other of the clamping blocks when in use.

The mounting axle and clamping blocks may be threaded so as to mount correspondingly-threaded clamping blocks on the axle. Thus, the arrangement may be such that the one or more stop devices may be a shoulder or end wall or thread end wall or region, where the thread ends. For example, in a preferred embodiment, a selected intermediate length of the axle may be unthreaded so that the clamping blocks cannot proceed onto the selected intermediate length. Preferably the intermediate length of the axle is of a length suitable to accommodate the thickness of the glass panes and a degree of compression of a seal assembly.

Preferably gripping means are provided so as to facilitate tightening of the clamping blocks. The gripping means may be any suitable means, such as for example a knurled surface, or simply a shaped periphery for receiving a tool, the arrangements contemplated, being hex-nut shaped clamping blocks, or elliptical-shaped clamping blocks. However, in a preferred embodiment, the gripping device is a tool receiving means, preferably a plurality of spaced-apart apertures on a surface of the clamping block.

Preferably the spacer apparatus is in the form of a spacer block including spacer faces for spreading a pane support load over a portion of the pane when assembled. Preferably the spacer is in the form of a donut, which includes a bore for receiving the axle when assembled. In one embodiment a shoulder is provided, which extends outwardly from the spacer faces, the shoulder being disposed adjacent the bore, for locating the spacer on a pane aperture, and for supporting a seal means and/or the or each glass pane. Preferably the shoulder includes a bevel to provide a ramp for pane aperture during assembly. The shoulder is adapted to, inter alia, inhibit the seal material or impurities such as external air from contacting the axle, and to define one boundary of a well for receiving flexible sealant.

Preferably the seal device is in the form of one or more seal elements, a first seal element being in the form of a washer so as to seal and provide suitable frictional and/or structural support, preferably being constructed from silicone. The seal device preferably further includes a barrier of a flexible sealant, which in one form is Polyisobutylene (PIB).

The spacer faces may also include grooves for locating the washer thereon, the grooves assisting in the retention of the washer in a selected position on the spacer face, in particular because the glass panes are kept in position at least in part by friction between the washers and the panes. A well or chamber may be provided adjacent each spacer face so that when assembled, the flexible sealant may be applied and be retained therein. Preferably each well or chamber is disposed between the spacer face, an inner edge of the washer, the respective pane face and the shoulder of the spacer. Preferably the bevel of the shoulder angles towards the axle axis, so as to increase the volume of the well.

A stem apparatus may be provided to operatively connect the point fixing apparatus to the support structure. The stem apparatus includes an articulated ball joint. The ball joint may be mounted in a housing which is adapted to connect to a threaded bore of the axle.

Advantageously, preferred embodiments of the point fixing apparatus inhibit the panes from moving independently of one another by friction and thus the Polyisobutylene is not required to cure to maintain rigidity of the fixing joint thus created.

The arrangement is such that the insulated glass unit includes a first pane of glass or other transparent or translucent sheeting, a second pane of glass or other transparent or translucent sheeting, a spacer mounted at a periphery of the panes and disposed between the first and second panes for spacing the panes from one another, and a seal between the spacer and the panes so that a chamber between the two panes is sealed from the external atmosphere.

According to another aspect of the present invention there is provided a method of mounting an insulated glass unit, the method including the steps of: supporting the insulated glass unit on point fixings which are spaced from a frame thereof.

Preferably the method includes a sub-assembly step, wherein a sub-assembly is formed by mounting a first pane of glass onto an axle, placing a spacer apparatus which includes one or more seal devices mounted in grooves on spacer faces through an aperture in the pane until at least one seal device abuts the glass pane, mounting a second pane of glass onto the axle, and mounting an outer washer onto the pane adjacent the aperture.

Preferably the method includes a flexible seal application step, wherein a flexible seal is applied from an outside face of each pane to a well adjacent the aperture, the well generally bounded by a shoulder of the spacer apparatus, a washer inner diameter, the spacer face and the pane.

Preferably the assembly step includes a clamping step, wherein clamping blocks are applied to outer thread regions of the axle and threaded until the clamping blocks abut stops mounted on or integral with the axle.

When one preferred embodiment of the point fixing means is assembled, the spacer is disposed between opposing faces of adjacent panes, while washer seals constructed from silicone are disposed on spacer faces and the pane faces for structural and frictional sealing and support. Polyisobutylene is applied to the inside circumference of the washer constructed from silicone so as to seal the glass chamber between the shoulder of the spacer and the washer. The hollow, internally and externally threaded axle is passed through aligned through holes in the first and second (and third if present) panes, through the bore of the spacer. The washers constructed from silicone are applied to the pane around the apertures and then polyisobutylene is applied between the aperture edge and the inside circumference of the washer. The clamping blocks are then applied to the washer and polyisobutylene before it cures, and then tightened onto the axle by connecting to the external thread thereof. A stem in the form of an articulated ball joint is connected to the threaded bore and may be articulated in or out of the threaded bore in order to separately adjust the shear supporting force so that its line of action passes through the ball.

### BRIEF DESCRIPTION OF THE DRAWINGS

In order to enable a clearer understanding, the invention will hereinafter be described with reference to drawings and description of preferred embodiments. In the drawings:

FIG. 1 is a section view of a proud-mount point fixing apparatus shown mounted in-situ on an insulated glass unit (IGU) in accordance with one preferred embodiment of the present invention;

FIG. 2 is a perspective view of the apparatus shown in FIG. 1;

FIG. 3 is a side elevation view of an axle which is a component of the apparatus shown in FIG. 1;

FIG. 4 is a side elevation view of the apparatus shown in FIG. 1 with hidden detail shown;

FIG. 5 is an isometric view of an IGU which is a second preferred embodiment of the present invention;

FIG. 6 is an isometric section view of the IGU shown in FIG. 5;

FIG. 7 is a detail view of a circled portion of FIG. 6;

FIG. 8 is a section view in side elevation of the second preferred embodiment shown in FIG. 5;

FIG. 9 is a detail view of a circled portion of the second preferred embodiment shown in FIG. 8;

FIGS. 10a-10d show several views of a countersunk washer which is a component of the second preferred embodiment of the present invention;

FIGS. 11a-11d show several view of a second countersunk washer;

FIGS. 12a-12c show several views of a countersunk bush;

FIGS. 13a-13c show several view of a countersunk bush;

FIGS. 14a-14c show several isometric views of a spacer used in the second embodiment;

FIGS. 15a-15d show several isometric views of a shee bolt which is used in the second embodiment.

### DETAILED DESCRIPTION OF THE PREFERRED EMBODIMENT

Referring to FIG. 1 there is shown a mounting device generally indicated at 10 which comprises a point fixing apparatus 12 suitable for mounting an insulated glass unit (IGU) 5. The IGU 5 is a window with an insulating chamber 7 disposed between at least two spaced apart panes of glass 2 and 3. The panes 2 and 3 are sealed around their peripheral region so as to provide the sealed insulating chamber 7.

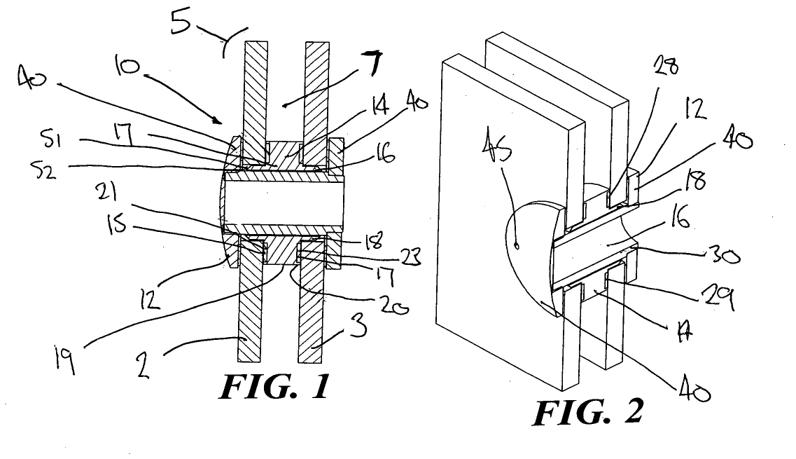

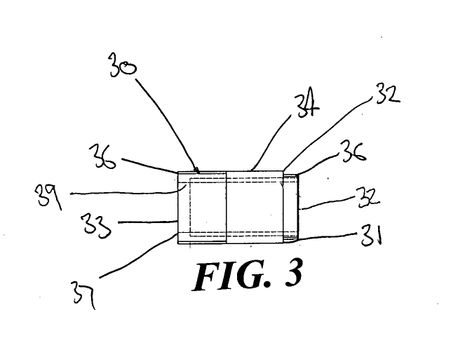

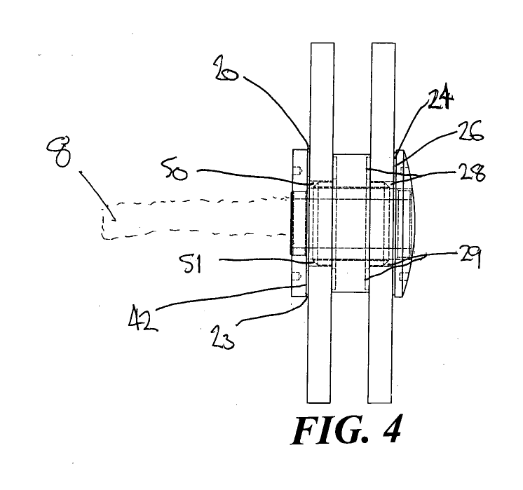

FIGS. 1-4 show a point fixing apparatus 12 for mounting the IGU 5. The point fixing apparatus 12 includes a spacer 14 which in use is disposed between the two panes of glass 2 and 3. The spacer 14 includes a through bore 16 and a pane locating and support flange 18 extending from faces 15 and 17. The point spacer 14 is generally shaped as a donut 17 and includes a circumferential face 19 and the two end spacer faces 15 and 17 have grooves 21 and 23 so as to provide a seal apparatus 20 comprising a flexible PIB sealant disposed in a well. Bevels 51 disposed at outer ends of the flange 18 provide a ramp 52 to facilitate loading of the panes 2 and 3 onto the flange 18.

An axle 30 is provided so as to support clamping blocks 40 and donut 17, the latter of which has a smooth bore which slides on axle 30. The axle 30 includes shaft 34 having threaded ends 36 as well as stops 31 and 33 so as to inhibit clamping blocks 40 from overtightening the point fixing apparatus 12. The stops 31 and 33 are, respectively, shoulder 32 and axle end 37 on the shaft 34.

The seal apparatus 20 also includes a first seal element 22 in the form of structural washers 23 and 24 which are constructed from silicone 26 in order to provide suitable flexibility, sealing and frictional and structural support for the panes 2 and 3. The seal apparatus 20 also includes a second seal element 28 in the form of a polyisobutylene sealant 29. The polyisobutylene (PIB) sealant 29, when the apparatus 12 is assembled, is applied in a 5.5 mm diameter bead to the spacer faces 15 and 17 in the grooves 21, 23 or well.

The seal apparatus 20 further includes a second well or chamber 50 for receiving flexible sealant adjacent the flange 18, and a bevel 51 at the end of the flange increases the well size so that a secure flexible PIB seal may be effected between the panes 2 and 3, flange 18 and internal diameters of the washers 24. The volume of the well 50 and hence the seal is maintained by the stops 31 and 33 which inhibit the clamping blocks 40 from squeezing out all the polyisobutylene 29. The stops 31 and 33 at their minimum spacing, generally define a separation distance which is a minimum specified thickness of glass panes 2 and 3, less a small separation for compression of the silicone washers 24.

To assemble the point fixing apparatus, a first pane 2 waits at an assembly station on a production line. The pane 2 has a peripheral bead of PIB sealant applied around its peripheral edges (not shown). The spacer 14 is loaded with 5.5 mm diameter beads of PIB on both faces 15 and 17, in the groove or wells 21, 23 and applied to the pane 2 in holes just larger than the diameter of flange 18. The spacer is squeezed against the pane 2 until the face 15 abuts it, leaving a PIB adhesive seal at least as deep as the groove. A second pane 3 is applied to the first pane 2, the pane 3 being located using the flange 18 of the spacer which inserts into a suitable hole in that pane. Pane 3 is squeezed against pane 2 so that PIB on face 17 is squeezed and spacer face 17 abuts pane 3.

Once the spacer has been applied to the inner faces of the panes 2, 3, the axle 30 may be inserted, and PIB is injected into the well 50, adjacent the bevel 51. Clamping blocks 40 are then threadably applied to the axle shaft 30, and the end faces 42 of the clamping blocks 40 abut the silicone washer 23, 24 so as to form a seal 20. The clamping blocks 40 spread the support load from the mounting means 10 and which clamp the panes against the seals so as to inhibit pollution and leakage into the chamber between the panes. When tightening the clamping blocks 40, they bottom out on the stops 31 and 33 so that the glass panes are not crushed or cracked.

The clamping blocks 40 also include gripping means 45 so that a tight seal may be effected, and a more secure load holding and spreading, by facilitating tightening the clamping blocks 40 on the axle 30 with tools.

The axle 30 includes a bore 32, which includes an internal thread 39, which is provided on the bore so that an installer may change the point of application of the shear load from the IGU 5 or remove an articulating ball joint altogether. The shear load of the IGU 5 is taken by the end of a stem 4 upon which is mounted an articulating ball joint 8. The articulating ball joint 8 may move in and out of the bore 32 until the shear load is taken through the ball joint 8 itself, which reduces shear forces. The articulating ball joint and stem can be removed from the bore 32 so as to facilitate flat packing of IGUs.

The stem 4 transfers the load to a structure when installed.

The well 50 volume is maintained by the various features of the preferred embodiments, being the frictional engagement of the silicone washers 24 with the panes 2 and 3, and the overtightening stops 31 and 33 so that the apparatus 12 does not require a cured wet connection before the IGU 5 may be moved or installed.

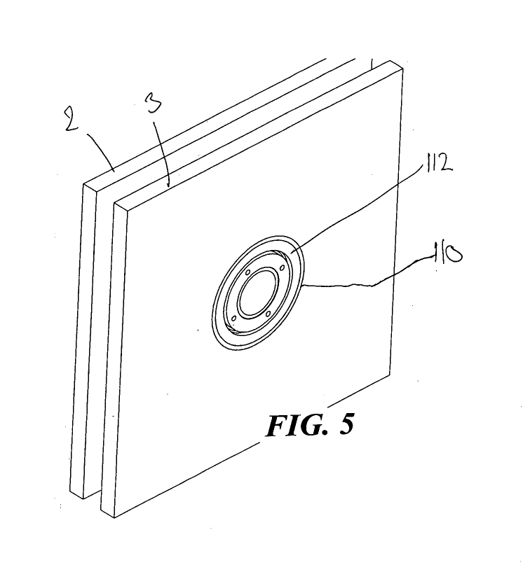

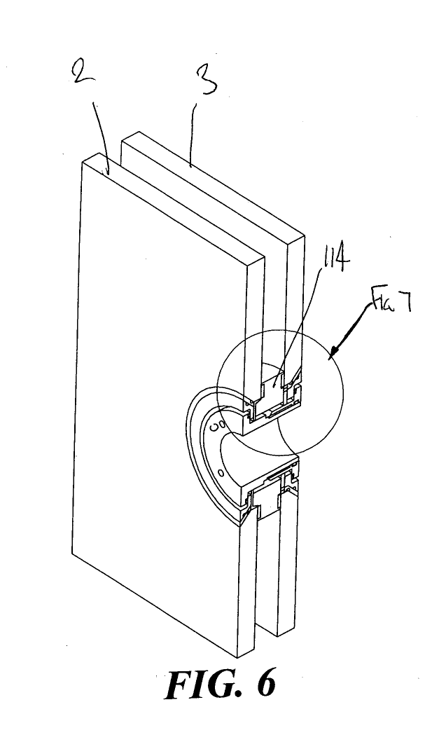

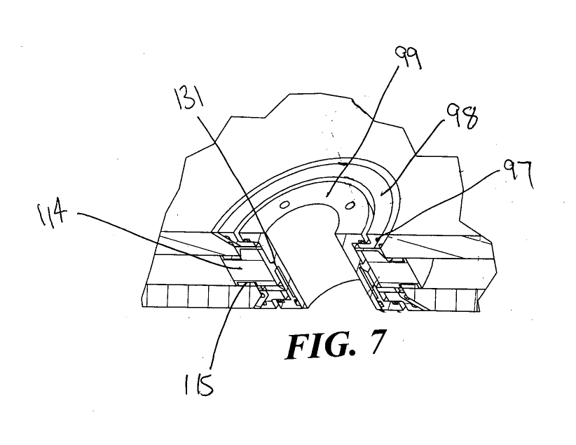

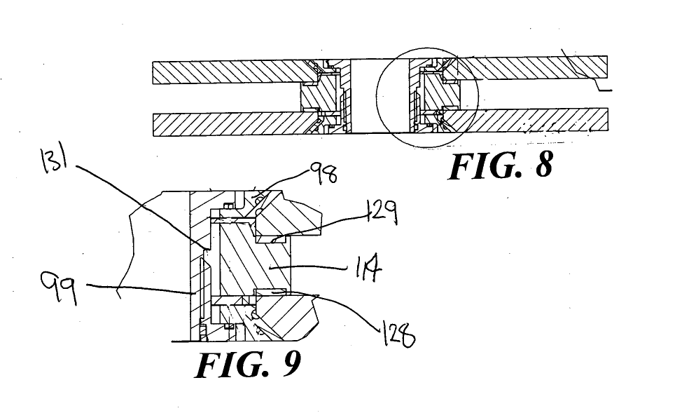

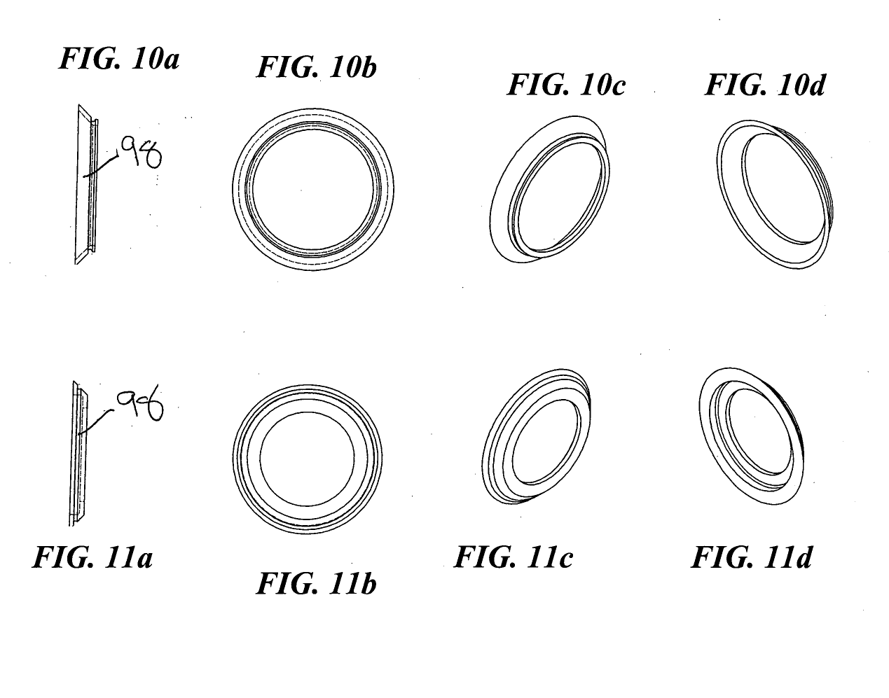

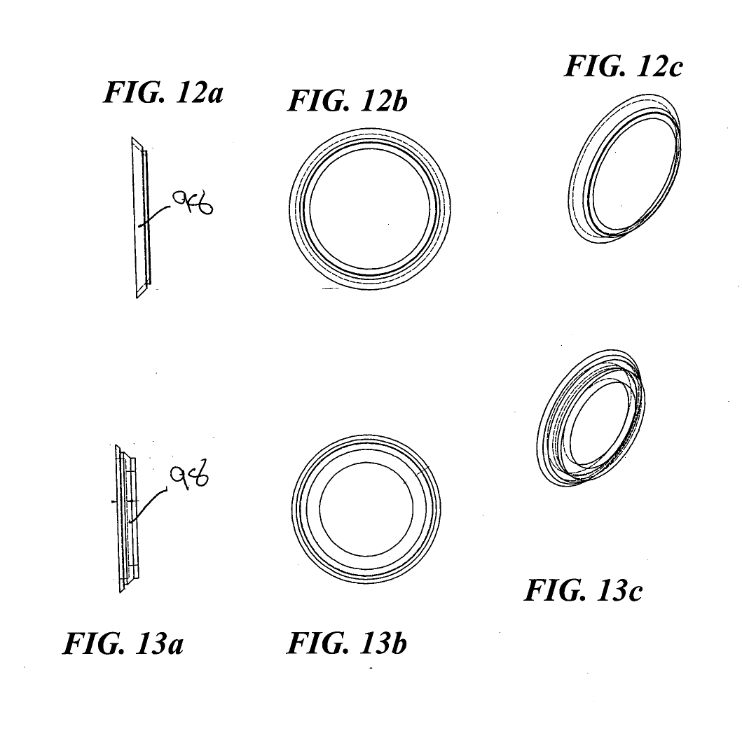

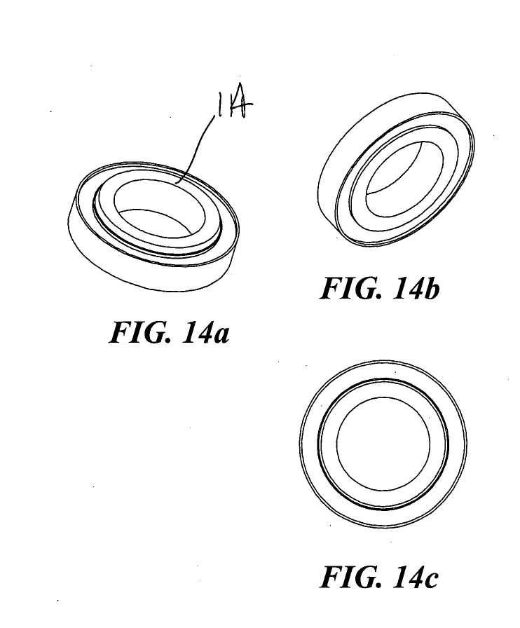

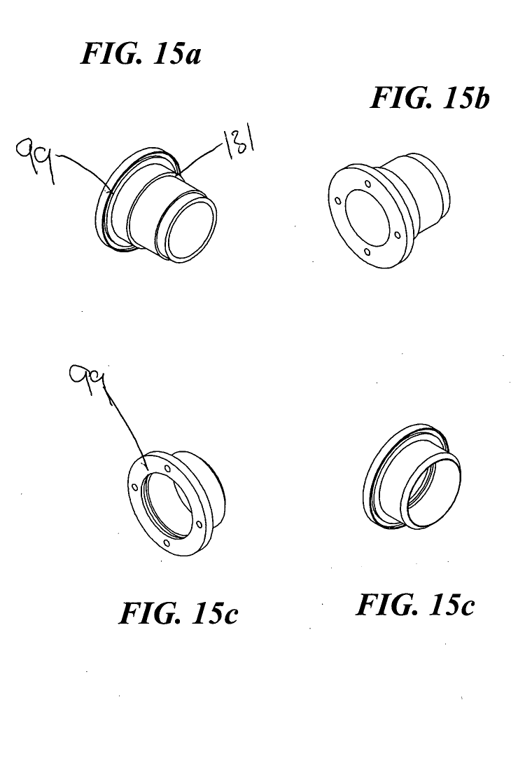

The second embodiment shown in FIGS. 5-15 works in a very similar way, and like numerals denote like parts. However, there are shee bolts 99 which hold countersunk bushes 98 against the panes 2, 3. The shee bolts 99 include stops 131 so as not to overtighten the apparatus 110. Finally, to improve sealing, the shee bolts, countersunk bushes and washers include o-rings 97.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Finally, it is to be understood that the inventive concept in any of its aspects can be incorporated in many different constructions so that the generality of the preceding description is not to be superseded by the particularity of the attached drawings. Various alterations, modifications and/or additions may be incorporated into the various constructions and arrangements of parts without departing from the spirit or ambit of the invention.

1. A point fixing apparatus for mounting an insulated glass unit (IGU) to a support structure, the IGU having first and second panes of glass spaced apart from one another, the point fixing apparatus including:
a spacer apparatus for spacing the first and second panes from one another;
a first clamping block configured for clamping the first glass pane against the spacer apparatus;
a second clamping block configured for clamping the second glass pane against the spacer apparatus; and
one or more stop devices configured to inhibit overtightening of the clamping blocks against the panes and spacer apparatus, the one or more stop devices disposed between the clamping blocks when assembled.

2. The point fixing apparatus of claim 1, further comprising an axle provided for supporting the clamping blocks when assembled.

3. The point fixing apparatus of claim 2 wherein, when assembled, the spacer apparatus is disposed on the axle.

4. The point fixing apparatus of claim 2 wherein the one or more stop devices are mounted on or integral with the axle.

5. The point fixing apparatus of claim 1 wherein the one or more stop devices may extend from or be connected to the spacer apparatus and abut against one or other of the clamping blocks when in use.

6. The point fixing apparatus of claim 2 wherein the axle and clamping blocks are threaded.

7. The point fixing apparatus of claim 2 wherein the one or more stop devices is a shoulder or axle end wall or thread end wall or region.

8. The point fixing apparatus of claim 1, further comprising gripping means provided so as to facilitate tightening of the clamping blocks.

9. The point fixing apparatus of claim 1 wherein the spacer apparatus includes spacer faces for spreading a pane support load over a portion of the pane when assembled.

10. The point fixing apparatus of claim 9, further comprising a flange, which extends outwardly from the spacer faces, the shoulder being disposed adjacent the bore, for locating the spacer on a pane aperture.

11. The point fixing apparatus of claim 1, further comprising a seal device, in the form of one or more seal elements, a first seal element being in the form of a washer so as to seal and provide suitable frictional and/or structural support, preferably being constructed from silicone.

12. The point fixing apparatus of claim 11 wherein the seal device includes a barrier of a flexible sealant, which in one form is Polyisobutylene (PIB).

13. The point fixing apparatus of claim 11 wherein the spacer faces include grooves for a well, so as to provide a sufficiently-deep PIB seal.

14. The point fixing apparatus of claim 1, further comprising a removable stem apparatus to operatively connect the point fixing apparatus to the support structure.

15. The point fixing apparatus of with claim 14 wherein the stem apparatus includes an articulated ball joint.

16. The point fixing apparatus of claim 15 wherein the ball joint may be mounted in a housing which is adapted to connect to a threaded bore of the axle.

17. An insulated glass unit (IGU) which includes:
first and second panes of glass;
point fixing apparatus for fixing the IGU to a support structure, the point fixing apparatus including a spacer for spacing the first and second panes from one another;
a first clamping block for clamping the first glass pane against the spacer when assembled;
a second clamping block for clamping the second glass pane against the spacer when assembled; and
one or more stop devices configured to inhibit overtightening of the clamping blocks against the panes and spacer apparatus, the one or more stop devices disposed between the clamping blocks when assembled.

18. (canceled)

19. (canceled)
